(19) United States
(12) Patent Application Publication
(10) Pub. No.: US 2019/0147385 A1
(43) Pub. Date: May 16, 2019

(54) METHOD AND SYSTEM FOR FACILITATING EVALUATION OF A COMPETENCE ASSOCIATED WITH A CANDIDATE

(71) Applicants: Ramprakash Narayanaswamy, San Jose, CA (US); Ramakrishna Rao Posinasri, Santa Clara, CA (US)

(72) Inventors: Ramprakash Narayanaswamy, San Jose, CA (US); Ramakrishna Rao Posinasri, Santa Clara, CA (US)

(21) Appl. No.: 15/815,553

(22) Filed: Nov. 16, 2017

(51) Int. Cl. G06Q 10/06; G06Q 10/10; G06F 17/27; H04L 12/58; G06Q 50/00

(52) U.S. Cl. CPC G06Q 10/06393; G06Q 10/1053; G06Q 50/01; G06F 17/277; H04L 51/046; G06Q 10/06398

(57) ABSTRACT

Disclosed is a method of facilitating evaluation of at least one competence associated with a candidate. The method may include receiving a resume associated with the candidate from a user device. Further, the method may include analyzing the resume to determine the at least one competence and identifying at least one expert based on the at least one competence. Further, the method may include establishing at least one evaluation session between a candidate device operated by the candidate and at least one expert device operated by the at least one expert and receiving at least one proficiency rating associated with the at least one competence from the at least one expert device. Further, the method may include storing the at least one proficiency rating in association with the at least one competence of the candidate.

### FIELD OF THE INVENTION

The present invention relates to data processing. In particular, the present invention relates to an online platform, a system and a method for assessing candidates.

### BACKGROUND OF THE INVENTION

The employment process is daunting for both employers and prospective employees. Employers are often forced to trust the information provided on a prospective employee's resume. If references are supplied, the employer is still forced to trust the word of a stranger, who may or may not have been coached by the prospective employee.

Further, the process of seeking a new position is arduous for prospective employees as well. These individuals are forced to sit through numerous interviews. The onerous process ensures that prospective employees are asked the same questions by multiple hiring managers.

Accordingly, there is a need for improved methods and systems for facilitating assessment of candidates that may overcome one or more of the abovementioned problems and/or limitations.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

Disclosed is a method of facilitating evaluation of at least one competence associated with a candidate. The method may include receiving, using a communication device, a resume associated with the candidate from a user device. Further, the method may include analyzing, using a processing device, the resume to determine the at least one competence. Further, the method may include identifying, using the processing device, at least one expert based on the at least one competence. Further, an expert identified based on a competence may be capable of evaluating the competence associated with the candidate. Further, the method may include establishing, using the communication device, at least one evaluation session between a candidate device operated by the candidate and at least one expert device operated by the at least one expert. Further, the method may include receiving, using the communication device, at least one proficiency rating associated with the at least one competence from the at least one expert device. Further, the method may include storing, using a storage device, the at least one proficiency rating in association with the at least one competence of the candidate.

According to further aspects, a system for facilitating evaluation of at least one competence associated with a candidate is provided. The system may include a communication device configured for receiving a resume associated with the candidate from a user device. Further, the communication device may be configured may for establishing at least one evaluation session between a candidate device operated by the candidate and at least one expert device operated by at least one expert. Further, the communication device may be configured for receiving at least one proficiency rating associated with the at least one competence from the at least one expert device. Yet further, the system may include a processing device configured for analyzing the resume to determine the at least one competence. Further, the processing device may be configured for identifying the at least one expert based on the at least one competence. Further, an expert identified based on a competence may be capable of evaluating the competence associated with the candidate. Moreover, the system may include a storage device configured for storing the at least one proficiency rating in association with the at least one competence of the candidate.

According to some aspects, a system for using experts to rate a prospective employee's skill level is provided. Further, the system may include connecting the rated employees with employers. Therefore, the disclosed system uses experts to assess the proficiency of a prospective employee, and then relays this information to employers seeking employees known to have the desired skillset. The system may automatically connect the prospective employees with experts capable of certifying the employees' proficiency in various skills.

According to some aspects, an online platform for recruitment is provided. The online platform may create a new job market for experts willing to vet the claims made by prospective employees. Further, the online platform enables prospective employees to be interviewed only by experts who assess their proficiency in certain skills. This enables employers to have the claims of prospective employees vetted by unbiased third parties. As a result, the prospective employee does not have to be interviewed by multiple hiring managers. All an employer has to do is view a prospective employee's proficiency rating to make sound hiring decisions.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 illustrates an exemplary environment in which embodiments of the present disclosure may be implemented.

FIG. 2 is a block diagram of a system for facilitating evaluation of one or more competences associated with a candidate, in accordance with some embodiments.

FIG. 3 illustrates a flowchart of a method for facilitating evaluation of one or more competences associated with a candidate, in accordance with some embodiments.

FIG. 4 illustrates a flowchart of a method for selecting exceptional candidates as experts, in accordance with some embodiments.

FIG. 5 illustrates a flowchart of a method for maintaining a log of the one or more evaluation sessions, in accordance with some embodiments.

FIG. 6 illustrates a flowchart of a method for obtaining feedback on the candidate's competence from one or more third parties, in accordance with some embodiments.

FIG. 7 illustrates a flowchart of a method for providing information about one or more candidates to a third party, in accordance with some embodiments.

FIG. 8 illustrates a flowchart of a method for rewarding experts for conducting the evaluation session, in accordance with some embodiments.

FIG. 9 illustrates a flowchart of a method for selecting an expert to evaluate a competence of the candidate based on a contextual match between the expert and the candidate, in accordance with some embodiments.

FIG. 10 illustrates a flowchart of a method for selecting an expert based on a social connection between the expert and a candidate, in accordance with some embodiments.

FIG. 11 illustrates a flowchart of a method for monitoring the one or more evaluation session, in accordance with some embodiments.

FIG. 12 illustrates a flowchart of a method for determining a validity of the one or more evaluation sessions, in accordance with some embodiments.

FIG. 13 illustrates a flowchart of a method for providing communication between one or more prospective employees and the online platform, in accordance with some embodiments.

FIG. 14 illustrates a flowchart of a method for providing communication between one or more experts and the online platform, in accordance with some embodiments.

FIG. 15 illustrates a flowchart of a method for providing communication between one or more employers and the online platform, in accordance with some embodiments.

FIG. 16 illustrates an exemplary computing system that may be employed to implement processing functionality for various embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of assessing candidates, embodiments of the present disclosure are not limited to use only in this context.

### Overview

According to some aspects, the present disclosure provides an online platform for recruitment that enables an employer to assess the skill of a prospective employee. The online platform may include a user interface (UI) engine, a profile engine, a credential engine, an analysis engine, a communications engine, a rating engine, and an employer engine. The term engine is used herein to refer to collections of programs which are grouped based upon function. The online platform may be designed to be run on computing devices such as desktops, laptops, mobile phones, and the like. The online platform may be configured to allow experts to rate a prospective employee's proficiency in the skills listed on her resume. Then, the prospective employee's proficiency rating may be used as a certification for employers seeking to fill a position with a skilled employee. Further, the online platform may enable a prospective employee to receive certifications for each skill listed on a resume, and thus grants employers a means for assessing the veracity of any listed claim.

In an embodiment, the UI engine may be tasked with relating information between users and the online platform. The UI engine may render all graphical interfaces that are displayed on the screens of computing devices accessing the online platform. Further, the UI engine may interpret user input. The profile engine may enable a user to register as an employer, a prospective employee, or an expert. An employer may be able to browse, as well as rate, the records of prospective employees and experts. A prospective employee may be able to upload resumes and receives communications from experts and employers. An expert may be able to send and receive messages from prospective employees and employers. Each user of the online platform may enter demographic information into a unique profile that may be associated with the respective user's account.

In an embodiment, the credential engine may enable prospective employees to upload resumes into the online platform. Additionally, the experts may upload documents to verify their position as an expert in a particular field. Once a prospective employee uploads a resume to the credentials engine, the data may be passed to the analysis engine. The analysis engine may parse through an uploaded resume to determine the skills a prospective employee has listed. Once the analysis engine has tokenized the resume, it may then determine the experts who may be capable of assessing the prospective employee's proficiency in a particular skill.

In an embodiment, the communications engine may facilitate communication between the users of the online platform. After the analysis engine has determined the appropriate experts, the communications engine may transmit messages to both the expert and the potential employee. This message begins the conversation between the expert and the prospective employee. Further, the communications engine may enable users to communicate through text, voice call, video calls, and the like. Additionally, the communications engine may coordinate the secure transmission of information between computing devices accessing the online platform.

In an embodiment, the rating engine may enable a user to assign ratings to various aspects of another user's profile. Furthermore, the rating engine may create a record of all rating information and formulate a normalized score for the rated aspects of a user's profile. Experts may be tasked with interviewing prospective employees through the communication engine. These interviews may then be used to assess the proficiency of a prospective employee in any number of skills identified by the analysis engine. After completing an interview, the expert may use the rating engine to assign a proficiency score to the prospective employee's profile. Further, the experts who perform interviews and rate prospective employees' skills proficiency may be compensated.

In an embodiment, the employer engine may enable employers to search for prospective employees and assess the credibility of an expert's ratings. The rating engine may enable an employer to rate an expert's profile. This rating may be associated with the expert's credibility, and it may identify whether or not the expert's ratings accurately express the skills of prospective employees. The employer engine may grant employers access to the profiles of multiple prospective employees. Additionally, the employer engine may enable employers to submit specific queries when searching for prospective employees with the desired skillset.

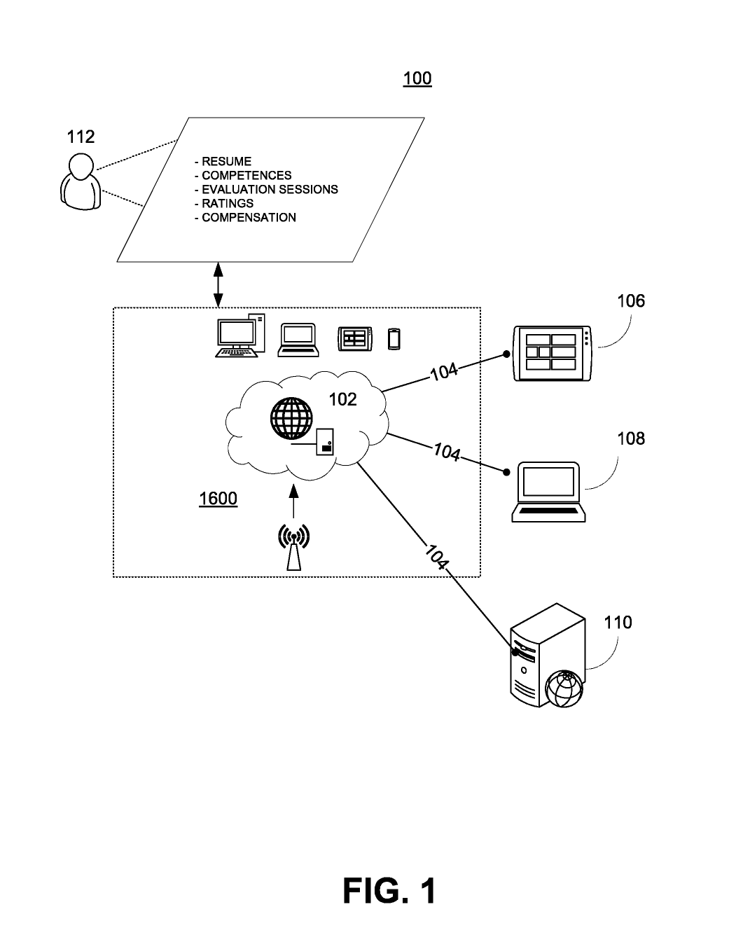

Referring now to figures, FIG. 1 is an illustration of a platform consistent with various embodiments of the present disclosure. By way of non-limiting example, the online platform 100 for facilitating evaluation of one or more competences associated with a candidate, may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 108 (such as, a desktop computer, etc.), and servers 110 over a communication network 104, such as, but not limited to, the

Internet. Further, users of the platform may include prospective employees (candidates), employers, experts, and administrators. Accordingly, electronic devices operated by the one or more relevant parties may be in communication with the platform 100.

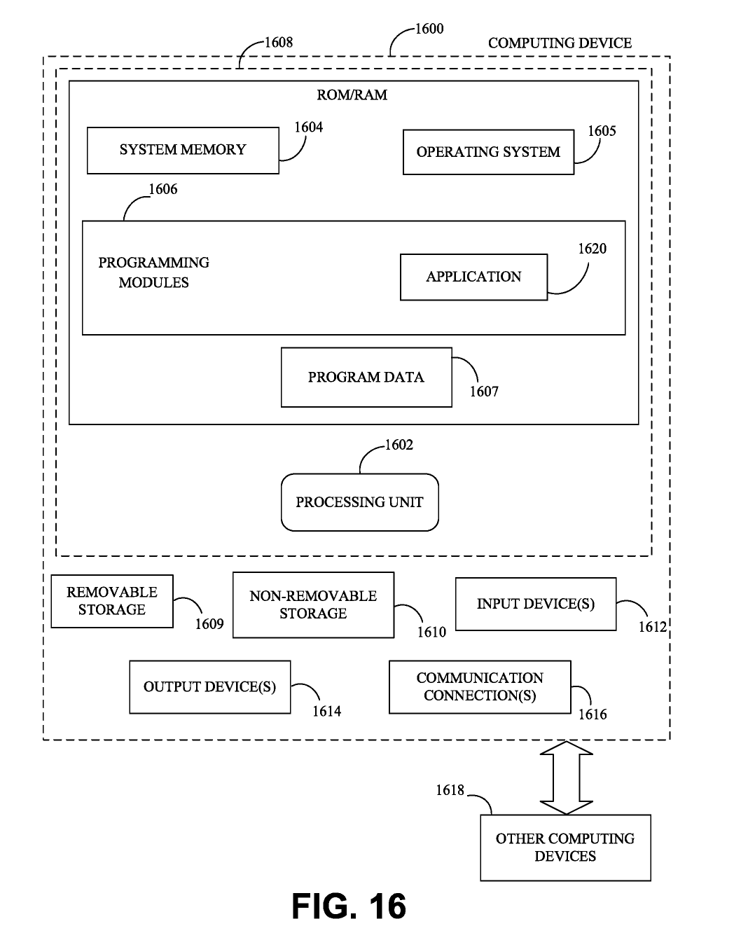

A user 112, such as the one or more relevant parties, may access platform 100 through a software application. The software application may be embodied as, for example, but not be limited to, a website, a web application, a desktop application, and a mobile application compatible with a computing device 1600. The computing device 1600 is explained in further detail in conjunction with FIG. 16 below.

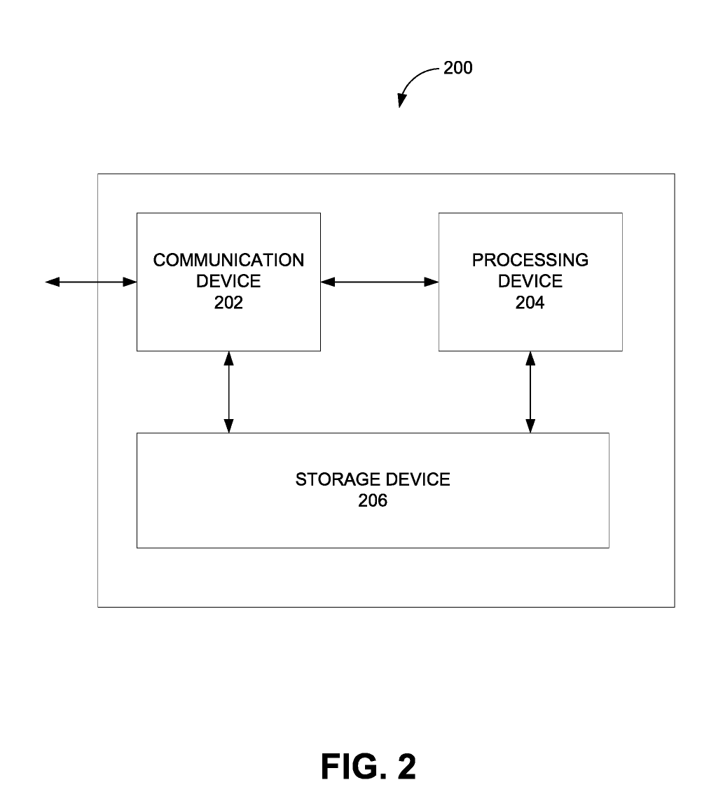

FIG. 2 is a block diagram of a system 200 for facilitating evaluation of one or more competences associated with a candidate, in accordance with some embodiments. For example, the one or more competences may include, but are not limited to, one or more of a skill, knowledge and/or behavioral traits, such as honesty, integrity, and morality.

The system 200 may include a communication device 202 configured for receiving a resume associated with the candidate from a user device. The user device may be operated by one or more of a candidate (such as a student, and a prospective employee) and a third party (such as, an employer, and an educational administrator).

Further, the communication device 202 may be configured may for establishing one or more evaluation sessions between a candidate device operated by the candidate and one or more expert devices operated by one or more experts. An evaluation session, in the one or more evaluation sessions, may be a communication session that may include, but not limited to, one or more forms of communication such as, textual communication (chat), audio communication (voice call), video communication (video call), screen sharing, and co-browsing.

Further, the communication device 202 may be configured for receiving one or more proficiency ratings associated with the one or more competences from the one or more expert devices.

Yet further, the system may include a processing device 204 configured for analyzing the resume to determine the one or more competences. The resume may be in one or more digital formats, such as text, audio, video, and multimedia. Accordingly, the corresponding analysis may include one or more of textual analysis (such as syntactic or semantic analysis), audio analysis (such as speech-to-text conversion), image analysis (such as Optical Character Recognition (OCR) and object recognition).

Further, the processing device 204 may be configured for identifying the one or more experts based on the one or more competences. An expert identified based on a competence may be capable of evaluating the competence associated with the candidate.

Moreover, the system 200 may include a storage device 206 configured for storing the one or more proficiency ratings in association with the one or more competences of the candidate.

In some embodiments, the processing device 204 may be further configured for comparing a proficiency rating in the one or more proficiency ratings with a predetermined threshold. Further, the proficiency rating may be associated with a competence in the one or more competences. The processing device 204 may be further configured for identifying the candidate as a prospective expert corresponding to the competence based on the proficiency rating exceeding the predetermined threshold. Further, the communication device 202 may be configured for transmitting an invitation to the candidate device. Further, the communication device 202 may be configured for receiving an acceptance of the invitation from the candidate device. The storage device 206 may be further configured for registering the candidate as an expert in association with the competence. Accordingly, a candidate who performs exceptionally well in relation to a competence may be offered to join the system 200 as an expert in the competence. Upon acceptance of such an offer, the candidate may be registered as an expert in the competence and may thus subsequently evaluate other candidates.

In some embodiments, the storage device 206 may be further configured for recording the one or more evaluation sessions. Further, the communication device 202 may be configured for receiving a request from a third-party device. The communication device 202 may be further configured for transmitting the one or more evaluation sessions to the third-party device based on the request. Therefore, for the interest of employers, the evaluation session may be recorded and provided on-request. Accordingly, an employer may review the evaluation session and understand the basis for the proficiency rating provided to the candidate with respect to a competence.

The communication device 202 may be further configured for receiving a third-party feedback from a user device. Further, the third-party feedback may be associated with a competence of the one or more competences of the candidate. The third-party feedback may be provided by one or more third-parties (such as employers and educational administrators). The processing device 204 may be further configured for comparing the third party feedback with the one or more proficiency ratings and determining at least one credibility of the one or more experts based on a result of the comparing. Therefore, the one or more third-parties may provide feedback on the candidate's competence based on a corresponding interaction between the candidate and the one or more third-parties. Accordingly, the feedback may be compared to the proficiency rating provided by an expert and the credibility of the expert may be determined (for example, increased or decreased) based on the comparison. In some embodiments, the communication device 202 may be further configured for receiving a search request including each of a competence indicator and a proficiency rating criterion from a requester device. The competence indicator may correspond to a competence of the one or more competences. The communication device 202 may be further configured for transmitting the proficiency rating and the resume of the candidate to the requester device. Further, the processing device 204 may be configured for comparing a proficiency rating of the one or more proficiency ratings with the proficiency rating criterion. The proficiency may be associated with the competence. The processing device 204 may be further configured for identifying the candidate as matching the search request based on the proficiency rating satisfying the proficiency rating criterion. Accordingly, the one or more third-parties may request the system 200 to display a list of candidates who possess proficiency in a particular competence based on a proficiency criterion (such as a minimum proficiency level, a maximum proficiency level, and a range of proficiency levels).

In some embodiments, the processing device 204 may be further configured for determining at least one monetary compensation associated with the one or more experts based on receiving the one or more proficiency ratings. Further, the processing device 204 may be configured for transferring the at least one monetary compensation to one or more accounts associated with the one or more experts. Accordingly, the one or more experts may be rewarded with the at least one monetary compensation for conducing the evaluation session and providing the proficiency rating for the candidate.

In some embodiments, the processing device 204 may be further configured for analyzing the resume to determine a candidate-context associated with the one or more competences. For example, the candidate-context may be based on, but not limited to, one or more of location, time, culture, language, and gender. The processing device 204 may be further configured for comparing the candidate-context with an expert-context of multiple experts. The one or more experts may be identified from the multiple experts based on a result of the comparing. Accordingly, the communication device 202 may be further configured for receiving the expert-context associated with the multiple experts. Therefore, an expert may be selected to evaluate a competence of the candidate based on a contextual match between the expert and the candidate. Accordingly, in some embodiments, an expert may be selected based on an affinity between the expert's context and the candidate's context. Alternatively, and/or additionally, in some embodiments, the expert may be selected based on an affinity between the expert's context and a third-party's context.

In some embodiments, the communication device 202 may be further configured for communicating with one or more social networking servers. Further, the communication may include transmitting each of a candidate identifier associated with the candidate and one or more expert identifiers associated with the one or more experts. The processing device 204 may be further configured for determining a social connection between the candidate and an expert of the one or more experts based on the communicating. Further, the processing device 204 may be configured for excluding the expert from the one or more experts based on determining the social connection. Therefore, the expert may be selected based on a social connection between the expert and the candidate. Accordingly, the system 200 may access data sources on the Internet (including social networking servers) in order to determine the social connection. For instance, if the system 200 determines that the candidate and the expert are connected on a professional network (such as LinkedIn™), the expert may not be considered for evaluating the candidate. Further, in some embodiments, the social connection may be characterized by a degree of social separation. Accordingly, the system 200 may further determine a degree of social separation between the candidate and the expert by analyzing the social network of the expert and the social network of the candidate. For instance, the system 200 may identify the expert as eligible for evaluating the candidate only of the expert is separated from the candidate by at least 3 levels of separation.

In some embodiments, the storage device 206 may be further configured for recording the one or more evaluation sessions. Further, the processing device 204 may be configured for analyzing the one or more evaluation sessions to determine one or more metrics associated with the one or more evaluation sessions. For example, the one or more metrics may include, but not limited to, a time duration of the evaluation session, number of questions, a number of exercises, a complexity of questions/exercises, a length of responses, and a number of correct responses. The processing device 204 may be further configured for comparing the one or more metrics with multiple metrics corresponding to multiple previous evaluation sessions corresponding to the one or more competences. Further, the processing device 204 may be configured for determining a validity of the one or more evaluation sessions based on a result of the comparing. Further, the storing of the one or more proficiency ratings may be based on the validity. Therefore, the evaluation session may be monitored and/or analyzed in order to determine one or more metrics. Accordingly, averages for the one or more metrics may be computed based on historical evaluation sessions. Such averages may be used as a benchmark for validating subsequent evaluation sessions.

In some embodiments, the processing device 204 may be further configured for analyzing the one or more evaluation sessions to determine one or more emotional states associated with the one or more experts and validating the one or more proficiency ratings based on the one or more emotional states. The storing of the one or more proficiency ratings may be based on the validating. Therefore, the evaluation session may be analyzed in order to detect correlates of emotional states. For example, by using speech analysis and facial expression analysis, the system 200 may determine if the expert was under a state of stress during the evaluation session. Accordingly, a validity of the evaluation session and/or the proficiency rating provided by the expert may be established.

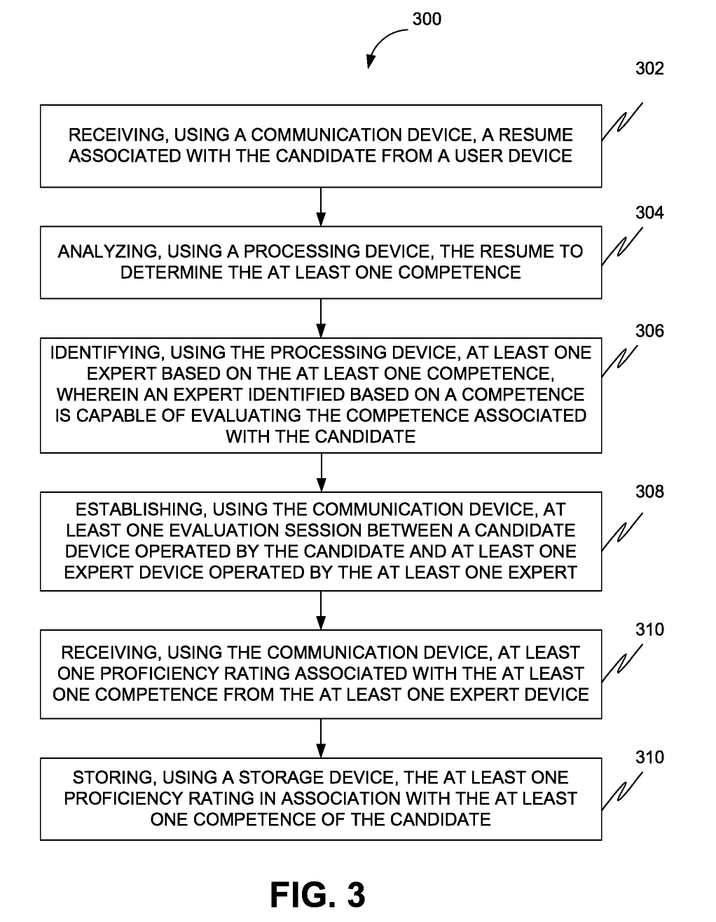

FIG. 3 illustrates a flowchart of a method 300 for facilitating evaluation of one or more competences associated with a candidate, in accordance with some embodiments.

For example, the one or more competences may include, but are not limited to, one or more of a skill, knowledge and/or behavioral traits, such as honesty, integrity, and morality. At 302, the method 300 may include receiving, using a communication device (such as a communication device 202), a resume associated with the candidate from a user device. The user device may be operated by one or more of a candidate (such as a student, and a prospective employee) and a third party (such as, an employer, and an educational administrator).

Then, at 304, the method 300 may include analyzing, using a processing device (such as a processing device 204), the resume to determine the one or more competences. The resume may be in one or more digital formats, such as text, audio, video, and multimedia. Accordingly, the corresponding analysis may include one or more of textual analysis (such as syntactic or semantic analysis), audio analysis (such as speech-to-text conversion), image analysis (such as Optical Character Recognition (OCR) and object recognition).

Further, at 306, the method 300 may include identifying, using the processing device, one or more experts based on the one or more competences. An expert may be identified based on a competence may be capable of evaluating the competence associated with the candidate.

At 308, the method 300 may include establishing, using the communication device, one or more evaluation sessions between a candidate device operated by the candidate and one or more expert devices operated by the one or more experts. An evaluation session, in the one or more evaluation sessions, may be a communication session that may include, but not limited to, one or more forms of communication such as, textual communication (chat), audio communication (voice call), video communication (video call), screen sharing, and co-browsing.

At 310, the method 300 may include receiving, using the communication device, one or more proficiency ratings associated with the one or more competences from the one or more expert devices. Further, at 312, the method 300 may include storing, using a storage device (such as the storing device 206), the one or more proficiency ratings in association with the one or more competences of the candidate.

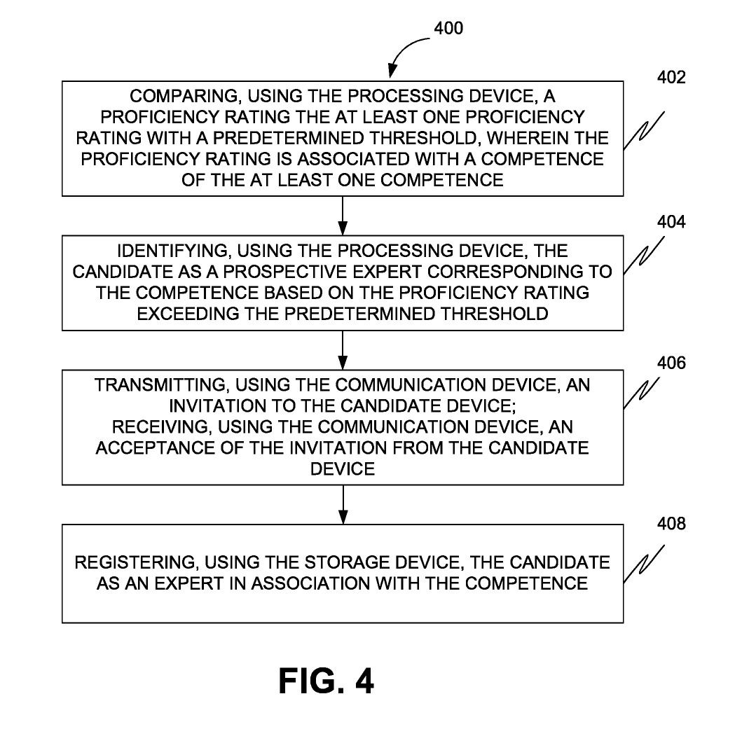

FIG. 4 illustrates a flowchart of a method 400 for selecting exceptional candidates as experts, in accordance with some embodiments. At 402, the method 400 may include comparing, using the processing device, a proficiency rating in the one or more proficiency ratings with a predetermined threshold. Further, the proficiency rating may be associated with a competence of the one or more competences. Further, at 404, the method 400 may include identifying, using the processing device, the candidate as a prospective expert corresponding to the competence based on the proficiency rating exceeding the predetermined threshold. Next, at 406, the method 400 may include transmitting, using the communication device, an invitation to the candidate device. Further, the method 400 may include receiving, using the communication device, an acceptance of the invitation from the candidate device. Thereafter, at 408, the method 400 may include registering, using the storage device, the candidate as an expert in association with the competence. Accordingly, a candidate who performs exceptionally well in relation to a competence may be offered to join as an expert in the competence. Upon acceptance of such an offer, the candidate may be registered as an expert in the competence and may thus subsequently evaluate other candidates.

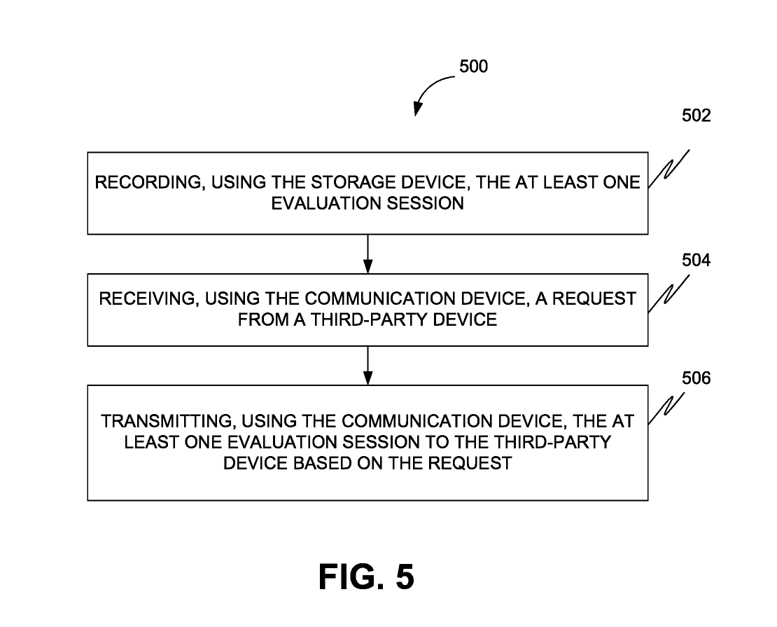

FIG. 5 illustrates a flowchart of a method 500 for maintaining a log of the one or more evaluation sessions, in accordance with some embodiments. At 502, the method 500 may further include recording, using the storage device, the one or more evaluation sessions. Further, at 504, the method 500 may include receiving, using the communication device, a request from a third-party device. Next, at 506, the method 500 may include transmitting, using the communication device, the one or more evaluation sessions to the third-party device based on the request. Therefore, for the interest of employers, the one or more evaluation sessions may be recorded and provided on-request. Accordingly, an employer may review the one or more evaluation sessions and understand the basis for the proficiency rating provided to the candidate with respect to a competence.

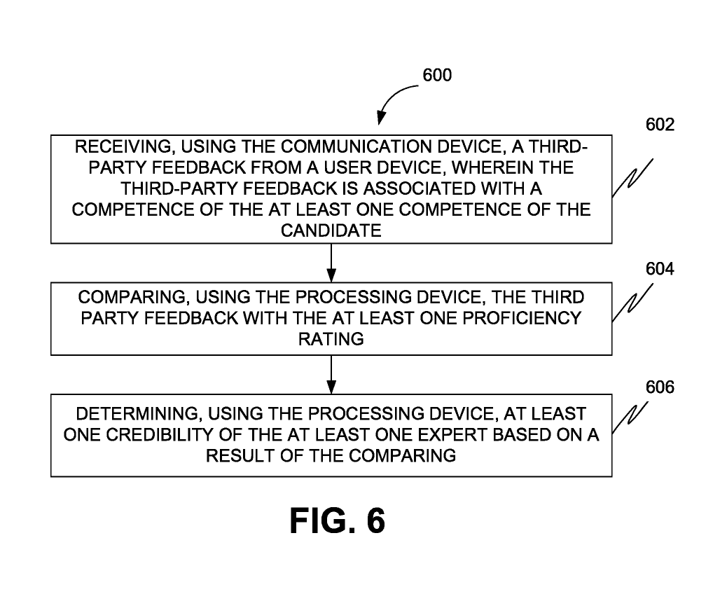

FIG. 6 illustrates a flowchart of a method 600 for obtaining feedback on the one or more competences of the candidate from one or more third parties, in accordance with some embodiments. At 602, the method 600 may further include receiving, using the communication device, a third-party feedback from a user device. The third-party feedback may be associated with a competence in the one or more competences of the candidate. Further, the feedback on the candidate's competence may be based on a corresponding interaction between the candidate and the one or more third-parties.

Further, at 604, the method 600 may include comparing, using the processing device, the third party feedback with the one or more proficiency ratings. Next, at 606, the method 600 may include determining, using the processing device, at least one credibility of the one or more experts based on a result of the comparing.

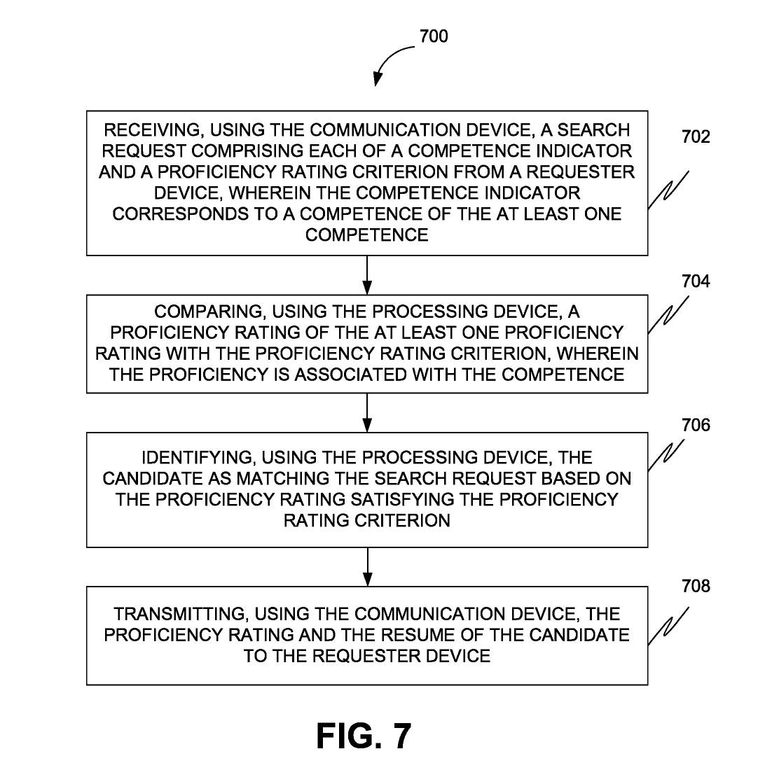

FIG. 7 illustrates a flowchart of a method 700 for providing information about one or more candidates to a third party, in accordance with some embodiments. At 702, the method 700 may include receiving, using the communication device, a search request including each of a competence indicator and a proficiency rating criterion from a requester device. The requester device may be operated by the third party. Further, the competence indicator may correspond to a competence of the one or more competences. Next, at 704, the method 700 may include comparing, using the processing device, a proficiency rating of the one or more proficiency ratings with the proficiency rating criterion. Further, the proficiency may be associated with the competence. At 706, the method 700 may include identifying, using the processing device, the candidate as matching the search request based on the proficiency rating satisfying the proficiency rating criterion. Next, at 708, the method 700 may include transmitting, using the communication device, the proficiency rating and the resume of the candidate to the requester device. Accordingly, the method 700 enables one or more third-parties to place a request for displaying a list of candidates who possess proficiency in a particular competence based on a proficiency criterion (such as a minimum proficiency level, a maximum proficiency level, and a range of proficiency levels).

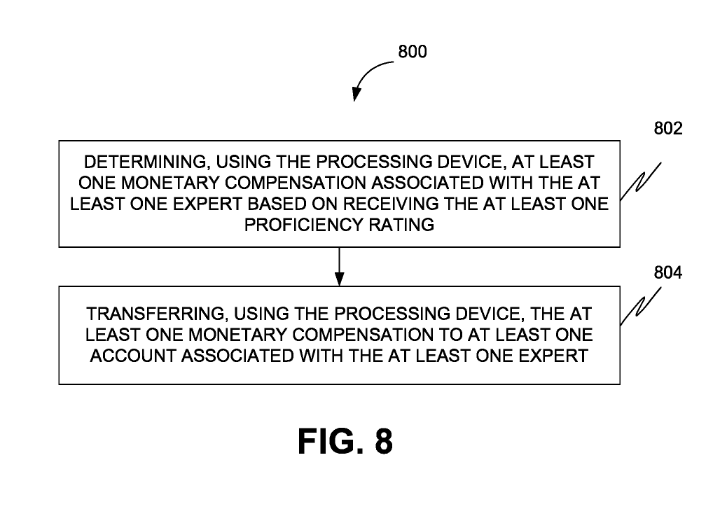

FIG. 8 illustrates a flowchart of a method 800 for rewarding the one or more experts for conducing the evaluation session, in accordance with some embodiments. At 802, the method 800 may further include determining, using the processing device, at least one monetary compensation associated with the one or more experts based on receiving the one or more proficiency ratings. Further, at 804, the method 800 may include transferring, using the processing device, the at least one monetary compensation to one or more accounts associated with the one or more experts.

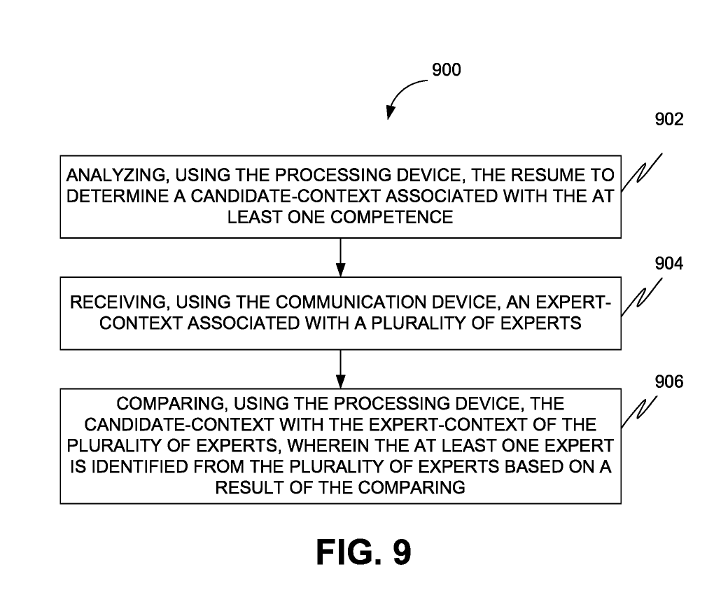

FIG. 9 illustrates a flowchart of a method 900 for selecting an expert to evaluate a competence of the candidate based on a contextual match between the expert and the candidate, in accordance with some embodiments. At 902, the method 900 may further include analyzing, using the processing device, the resume to determine a candidate-context associated with the one or more competences. Further, at 904, the method 900 may include receiving, using the communication device, an expert-context associated with multiple experts. Next, at 906, the method 900 may include comparing, using the processing device, the candidate-context with the expert-context of the multiple experts. The one or more experts may be identified from the multiple experts based on a result of the comparing. Accordingly, in some embodiments, an expert may be selected based on an affinity between the expert's context and the candidate's context. Alternatively, and/or additionally, in some embodiments, the expert may be selected based on an affinity between the expert's context and a third-party's context.

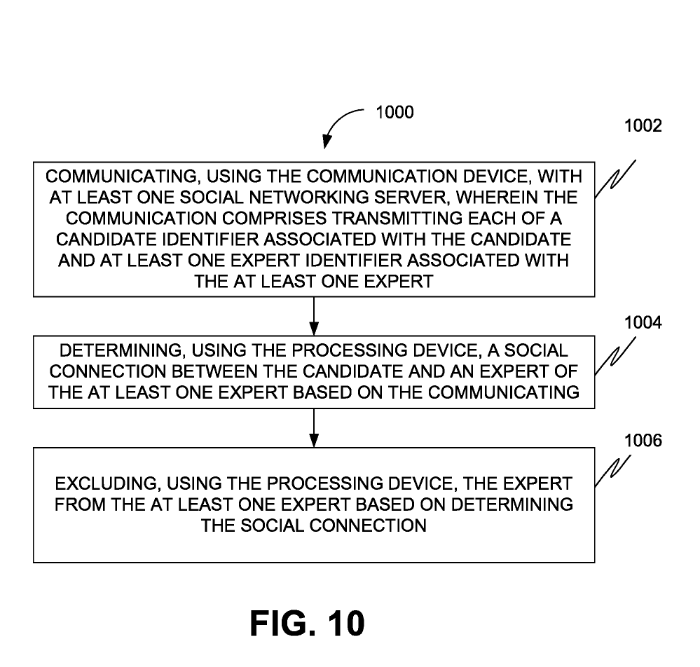

FIG. 10 illustrates a flowchart of a method 1000 for selecting an expert based on a social connection between the expert and the candidate, in accordance with some embodiments. At 1002, the method 1000 may further include communicating, using the communication device, with one or more social networking servers. The communication may include transmitting each of a candidate identifier associated with the candidate and one or more expert identifiers associated with the one or more experts. Further, at 1004, the method 100 may include determining, using the processing device, a social connection between the candidate and an expert of the one or more experts based on the communicating. Next, at 1006, the method 1000 may include excluding, using the processing device, the expert from the one or more experts based on determining the social connection.

Therefore, the expert may be selected based on a social connection between the expert and the candidate. Accordingly, the data sources on the Internet (including social networking servers) may be accessed in order to determine the social connection. For instance, if it is determined that the candidate and the expert are connected on a professional network (such as LinkedIn™), then the expert may not be considered for evaluating the candidate. Further, in some embodiments, the social connection may be characterized by a degree of social separation. Accordingly, the method 1000 may include determining a degree of social separation between the candidate and the expert by analyzing the social network of the expert and the social network of the candidate. For instance, the method 1000 may include identifying the expert as eligible for evaluating the candidate only of the expert is separated from the candidate by at least 3 levels of separation.

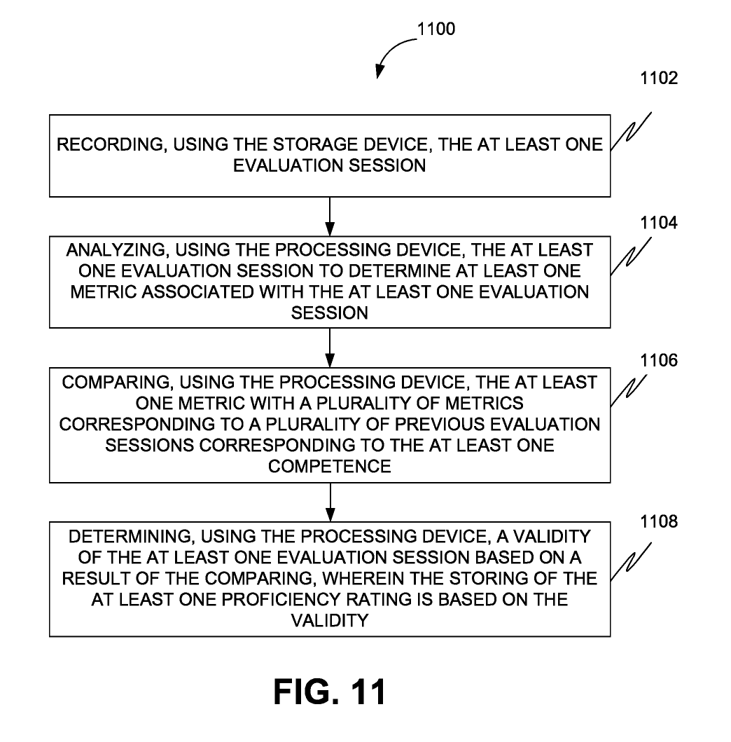

FIG. 11 illustrates a flowchart of a method 1100 for monitoring the one or more evaluation sessions, in accordance with some embodiments. At 1102, the method 1100 may include recording, using the storage device, the one or more evaluation sessions. Further, at 1104, the method 1100 may include analyzing, using the processing device, the one or more evaluation sessions to determine one or more metrics associated with the one or more evaluation sessions. Next, at 1106, the method 1100 may include comparing, using the processing device, the one or more metrics with multiple metrics corresponding to multiple previous evaluation sessions corresponding to the one or more competences. Further, at 1108, the method 1100 may include determining, using the processing device, a validity of the one or more evaluation sessions based on a result of the comparing. The storing of the one or more proficiency ratings may be based on the validity.

Accordingly, the one or more evaluation sessions may be monitored and/or analyzed in order to determine one or more metrics. Further, averages for the one or more metrics may be computed based on historical evaluation sessions. Such averages may be used as a benchmark for validating subsequent evaluation sessions.

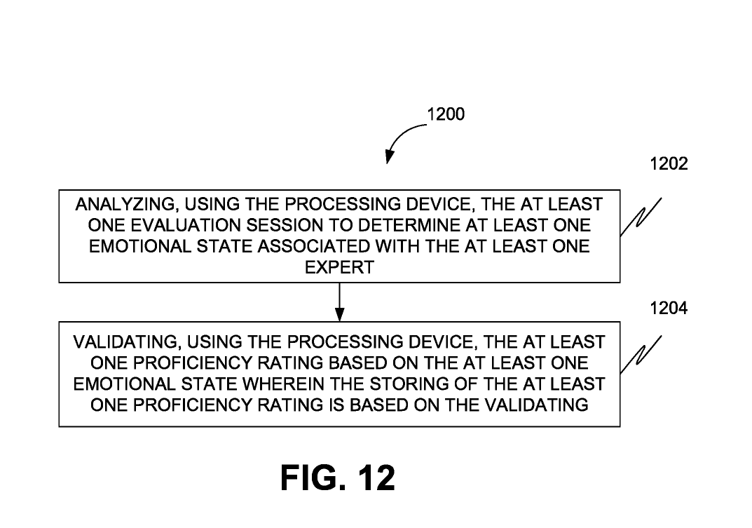

FIG. 12 illustrates a flowchart of a method 1200 for determining a validity of the one or more evaluation sessions, in accordance with some embodiments. At 1202, the method 1200 may further include analyzing, using the processing device, the one or more evaluation sessions to determine one or more emotional states associated with the one or more experts. Further, at 1204, the method 1200 may include validating, using the processing device, the one or more proficiency ratings based on the one or more emotional states wherein the storing of the one or more proficiency ratings may be based on the validating.

Therefore, the one or more evaluation sessions may be analyzed in order to detect correlates of emotional states. For example, by using speech analysis and facial expression analysis, the method 1200 may include determining if the expert was under a state of stress during the evaluation session. Accordingly, a validity of the evaluation session and/or the proficiency rating provided by the expert may be established.

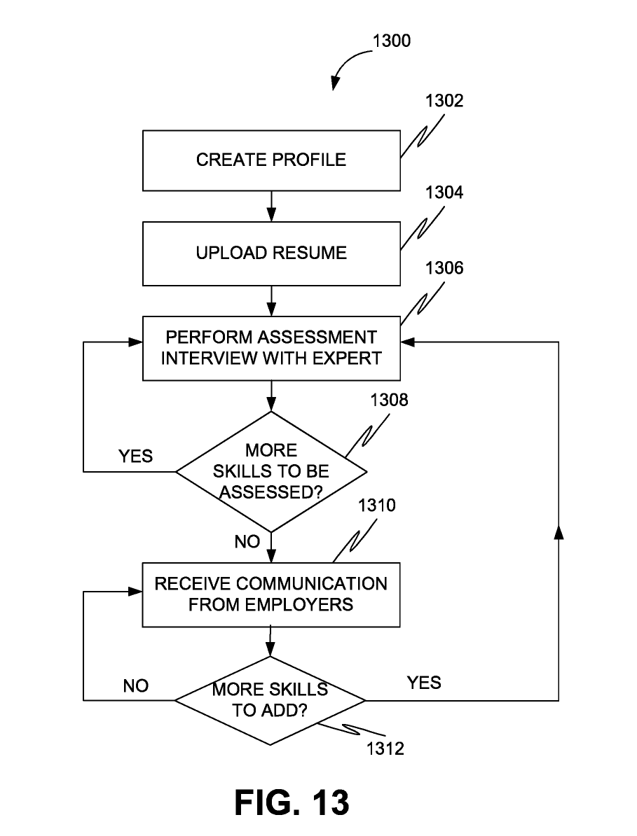

FIG. 13 illustrates a flowchart of a method 1300 for providing communication between one or more prospective employees and the online platform 100, in accordance with some embodiments. At 1302, the method 1300 may include creating one or more profiles by the one or more prospective employees on the online platform 100. Then, at 1304, the method 1300 may include uploading one or more resumes by the one or more prospective employees on the online platform 100. Thereafter, at 1306, the method 1300 may include undertaking an assessment interview with the one or more prospective employees by one or more experts. Then, at 1308, the method 1300 may include determining if more skills of the one or more prospective employees need to be assessed. If it is determined that more skills of the one or more prospective employees need to be assessed, then the method 1300 goes back to 1306 for further assessment. However, if it is determined that more skills of the one or more prospective employees need not be assessed, then the method goes to 1310. At 1310, the method 1300 may include receiving further information from one or more employers. Based on this information, the method 1300 may include determining if more skills need to be added at 1312. If it is determined that more skills need to be added, then the method 1300 goes back to 1306. However, if it is determined that more skills need not be added, then the method 1300 goes back to 1310.

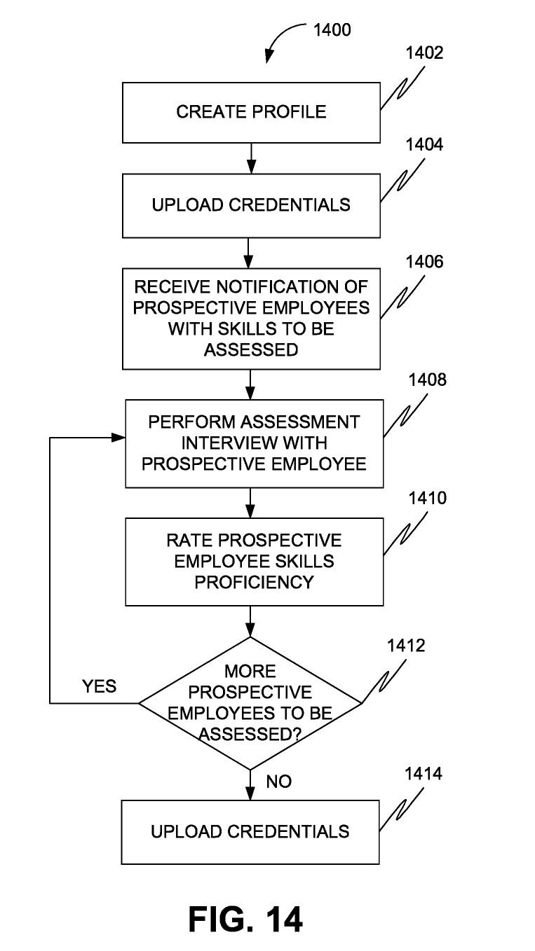

FIG. 14 illustrates a flowchart of a method 1400 for providing communication between one or more experts and the online platform 100, in accordance with some embodiments. At 1402, the method 1400 may include creating one or more profiles by the one or more experts on the online platform 100. Then, at 1404, the method 1400 may include the one or more experts uploading their credentials on the online platform 100. Thereafter, at 1406, the method 1400 may include receiving one or more notifications of the one or more prospective employees with skills to be assessed by the one or more experts. Further, at 1408, the method 1400 may include the one or more experts performing one or more assessment interviews with the one or more prospective employees. Then, at 1410, the method 1400 may include rating the skills proficiency of the one or more prospective employees. Next, at 1412, the method 1400 may include determining if more prospective employees need to be assessed. If it is determined that more prospective employees need to be assessed, the method 1400 may go back to 1408. However, if it is determined that no prospective employee is left to be assessed, then the method 1400 may include the one or more experts uploading the credentials at 1414.

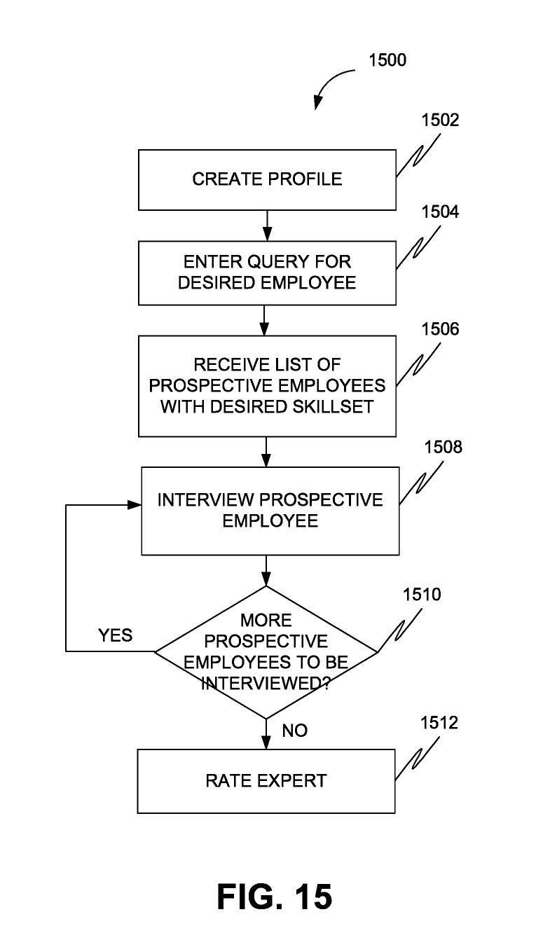

FIG. 15 illustrates a flowchart of a method 1500 for providing communication between one or more employers and the online platform 100, in accordance with some embodiments. At 1502, the method 1500 may include creating one or more profiles by the one or more employers on the online platform 100. Then, at 1504, the method 1500 may include the one or more employers entering one or more queries to search for one or more desired employees. In response, at 1506, the method 1500 may include receiving a list of prospective employees with desired skillset. Next, at 1508, the method 1500 may include

Interviewing one or more prospective employees in the list of prospective employees. Then, at 1510, the method 1500 may include determining if one or more prospective employees need to be interviewed. If it is determined that one or more prospective employees need to be interviewed, then the method 1500 may go back to 1508. However, if it is determined that no prospective employee is left to be interviewed, then the method 1500 may include the one or more employers rating one or more experts.

Further, in some embodiments, the method may enable an employer and the candidate to be mutually matched based on a job description provided by the employer and the at least one proficiency rating associated with the candidate. Accordingly, the method may include a step of receiving, using the communication device, a job description from a database comprising job descriptions associated with a plurality of employers. For example, the online platform may retrieve job descriptions from a job portal. Further, the method may include a step of analyzing, using the processing device, the job description to determine at least one competency requirement. For instance, the online platform may perform one or more of keyword extraction and/or NLP based text processing on the job description. Further, the at least one competency requirement may include indication of a competency and a proficiency level expected by the employer. Further, the method may include a step of identifying, using the processing device, the candidate based on the at least one competency requirement and the at least one proficiency rating. In other words, the candidate may be identified as satisfying the requirements of the job description in terms of the competency required and the proficiency level of the competency expected by the employer. Accordingly, the online platform may include a step of generating, using the processing device, a contract based on the job description and/or the resume of the candidate. For example, the contract may be for a part-time employment and/or for full-time employment. Further, the method may include a step of transmitting, using the communication device, a contract to a user device associated with at least one of the candidate and the employer based on identifying the candidate. Accordingly, the online platform may proactively suggest suitable candidates to employers.

FIG. 16 is a block diagram of a system including computing device 1600. Consistent with an embodiment of the disclosure, the aforementioned memory storage and processing unit may be implemented in a computing device, such as computing device 1600 of FIG. 16. Any suitable combination of hardware, software, or firmware may be used to implement the memory storage and processing unit. For example, the memory storage and processing unit may be implemented with computing device 1600 or any of other computing devices 1618, in combination with computing device 1600. The aforementioned system, device, and processors are examples and other systems, devices, and processors may comprise the aforementioned memory storage and processing unit, consistent with embodiments of the disclosure.

With reference to FIG. 16, a system consistent with an embodiment of the disclosure may include a computing device or cloud service, such as computing device 1600. In a basic configuration, computing device 1600 may include at least one processing unit 1602 and a system memory 1604. Depending on the configuration and type of computing device, system memory 1604 may comprise, but is not limited to, volatile (e.g. random access memory (RAM)), non-volatile (e.g. read-only memory (ROM)), flash memory, or any combination. System memory 1604 may include operating system 1605, one or more programming modules 1606, and may include a program data 1607. Operating system 1605, for example, may be suitable for controlling computing device 1600's operation. In one embodiment, programming modules 1606 may include image encoding module, machine learning module and image classifying module. Furthermore, embodiments of the disclosure may be practiced in conjunction with a graphics library, other operating systems, or any other application program and is not limited to any particular application or system. This basic configuration is illustrated in FIG. 16 by those components within a dashed line 1608.

Computing device 1600 may have additional features or functionality. For example, computing device 1600 may also include additional data storage devices (removable and/or non-removable) such as, for example, magnetic disks, optical disks, or tape. Such additional storage is illustrated in FIG. 16 by a removable storage 1609 and a non-removable storage 1610. Computer storage media may include volatile and nonvolatile, removable and non-removable media implemented in any method or technology for storage of information, such as computer-readable instructions, data structures, program modules, or other data. System memory 1604, removable storage 1609, and non-removable storage 1610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1600. Any such computer storage media may be part of device 1600. Computing device 1600 may also have input device(s) 1612 such as a keyboard, a mouse, a pen, a sound input device, a touch input device, etc. Output device(s) 1614 such as a display, speakers, a printer, etc. may also be included. The aforementioned devices are examples and others may be used.

Computing device 1600 may also contain a communication connection 1616 that may allow device 1600 to communicate with other computing devices 1618, such as over a network in a distributed computing environment, for example, an intranet or the Internet. Communication connection 1616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1604, including operating system 1605. While executing on processing unit 1602, programming modules 1606 (e.g., application 1620) may perform processes including, for example, one or more stages of methods 300, 400 500, 600, 700, 800, 900, 1000, 1100, 1200, 1300, 1400 and 1500 as described above. The aforementioned process is an example, and processing unit 1602 may perform other processes.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may, in fact, be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

I/we claim:

1. A method of facilitating evaluation of at least one competence associated with a candidate, the method comprising:
receiving, using a communication device, a resume associated with the candidate from a user device;
analyzing, using a processing device, the resume to determine the at least one competence;
identifying, using the processing device, at least one expert based on the at least one competence, wherein an expert identified based on a competence is capable of evaluating the competence associated with the candidate;
establishing, using the communication device, at least one evaluation session between a candidate device operated by the candidate and at least one expert device operated by the at least one expert;
receiving, using the communication device, at least one proficiency rating associated with the at least one competence from the at least one expert device; and
storing, using a storage device, the at least one proficiency rating in association with the at least one competence of the candidate.

2. The method of claim 1 further comprising:
comparing, using the processing device, a proficiency rating in the at least one proficiency rating with a predetermined threshold, wherein the proficiency rating is associated with a competence of the at least one competence;
identifying, using the processing device, the candidate as a prospective expert corresponding to the competence based on the proficiency rating exceeding the predetermined threshold;
transmitting, using the communication device, an invitation to the candidate device;
receiving, using the communication device, an acceptance of the invitation from the candidate device; and
registering, using the storage device, the candidate as an expert in association with the competence.

3. The method of claim 1 further comprising:
recording, using the storage device, the at least one evaluation session;
receiving, using the communication device, a request from a third-party device; and
transmitting, using the communication device, the at least one evaluation session to the third-party device based on the request.

4. The method of claim 1 further comprising:
receiving, using the communication device, a third-party feedback from a user device, wherein the third-party feedback is associated with a competence of the at least one competence of the candidate;
comparing, using the processing device, the third party feedback with the at least one proficiency rating; and
determining, using the processing device, at least one credibility of the at least one expert based on a result of the comparing.

5. The method of claim 1 further comprising:
receiving, using the communication device, a search request comprising each of a competence indicator and a proficiency rating criterion from a requester device, wherein the competence indicator corresponds to a competence of the at least one competence;
comparing, using the processing device, a proficiency rating of the at least one proficiency rating with the proficiency rating criterion, wherein the proficiency is associated with the competence;
identifying, using the processing device, the candidate as matching the search request based on the proficiency rating satisfying the proficiency rating criterion; and
transmitting, using the communication device, the proficiency rating and the resume of the candidate to the requester device.

6. The method of claim 1 further comprising:
determining, using the processing device, at least one monetary compensation associated with the at least one expert based on receiving the at least one proficiency rating; and
transferring, using the processing device, the at least one monetary compensation to at least one account associated with the at least one expert.

7. The method of claim 1 further comprising:
analyzing, using the processing device, the resume to determine a candidate-context associated with the at least one competence;
receiving, using the communication device, an expert-context associated with a plurality of experts; and
comparing, using the processing device, the candidate-context with the expert-context of the plurality of experts, wherein the at least one expert is identified from the plurality of experts based on a result of the comparing.

8. The method of claim 1 further comprising:
communicating, using the communication device, with at least one social networking server, wherein the communication comprises transmitting each of a candidate identifier associated with the candidate and at least one expert identifier associated with the at least one expert;
determining, using the processing device, a social connection between the candidate and an expert of the at least one expert based on the communicating; and
excluding, using the processing device, the expert from the at least one expert based on determining the social connection.

9. The method of claim 1 further comprising:
recording, using the storage device, the at least one evaluation session;
analyzing, using the processing device, the at least one evaluation session to determine at least one metric associated with the at least one evaluation session;
comparing, using the processing device, the at least one metric with a plurality of metrics corresponding to a plurality of previous evaluation sessions corresponding to the at least one competence; and
determining, using the processing device, a validity of the at least one evaluation session based on a result of the comparing, wherein the storing of the at least one proficiency rating is based on the validity.

10. The method of claim 1 further comprising:
analyzing, using the processing device, the at least one evaluation session to determine at least one emotional state associated with the at least one expert; and
validating, using the processing device, the at least one proficiency rating based on the at least one emotional state wherein the storing of the at least one proficiency rating is based on the validating.

11. The method of claim 1 further comprising:
receiving, using the communication device, a job description from a database comprising job descriptions associated with a plurality of employers;
analyzing, using the processing device, the job description to determine at least one competency requirement;
identifying, using the processing device, the candidate based on the at least one competency requirement and the at least one proficiency rating; and
transmitting, using the communication device, a contract to a user device associated with at least one of the candidate and the employer based on identifying the candidate.

12. A system for facilitating evaluation of at least one competence associated with a candidate, the system comprising:
a communication device configured for:
receiving a resume associated with the candidate from a user device;
establishing at least one evaluation session between a candidate device operated by the candidate and at least one expert device operated by at least one expert;
receiving at least one proficiency rating associated with the at least one competence from the at least one expert device;
a processing device configured for:
analyzing the resume to determine the at least one competence;
identifying the at least one expert based on the at least one competence, wherein an expert identified based on a competence is capable of evaluating the competence associated with the candidate; and
a storage device configured for storing the at least one proficiency rating in association with the at least one competence of the candidate.

13. The system of claim 12, wherein the processing device is further configured for:
comparing a proficiency rating in the at least one proficiency rating with a predetermined threshold, wherein the proficiency rating is associated with a competence of the at least one competence; and
identifying the candidate as a prospective expert corresponding to the competence based on the proficiency rating exceeding the predetermined threshold; and wherein the communication device is further configured for:
transmitting an invitation to the candidate device; and
receiving an acceptance of the invitation from the candidate device; and wherein the storage device is further configured for registering the candidate as an expert in association with the competence.

14. The system of claim 12, wherein the storage device is further configured for recording the at least one evaluation session; and wherein the communication device is further configured for:
receiving a request from a third-party device; and
transmitting the at least one evaluation session to the third-party device based on the request.

15. The system of claim 12, wherein the communication device is further configured for:
receiving a third-party feedback from a user device, wherein the third-party feedback is associated with a competence of the at least one competence of the candidate; and wherein the processing device is further configured for:
comparing the third party feedback with the at least one proficiency rating; and
determining at least one credibility of the at least one expert based on a result of the comparing.

16. The system of claim 12, wherein the communication device is further configured for:
receiving a search request comprising each of a competence indicator and a proficiency rating criterion from a requester device, wherein the competence indicator corresponds to a competence of the at least one competence; and
transmitting the proficiency rating and the resume of the candidate to the requester device; and wherein the processing device is configured for:
comparing a proficiency rating of the at least one proficiency rating with the proficiency rating criterion, wherein the proficiency is associated with the competence; and
identifying the candidate as matching the search request based on the proficiency rating satisfying the proficiency rating criterion.

17. The system of claim 12, wherein the processing device is further configured for:
determining at least one monetary compensation associated with the at least one expert based on receiving the at least one proficiency rating; and
transferring the at least one monetary compensation to at least one account associated with the at least one expert.

18. The system of claim 12, wherein the processing device is further configured for:
analyzing the resume to determine a candidate-context associated with the at least one competence; and
comparing the candidate-context with an expert-context of a plurality of experts, wherein the at least one expert is identified from the plurality of experts based on a result of the comparing; and wherein the communication device is further configured for receiving the expert-context associated with the plurality of experts.

19. The system of claim 12, wherein the communication device is further configured for:
communicating with at least one social networking server, wherein the communication comprises transmitting each of a candidate identifier associated with the candidate and at least one expert identifier associated with the at least one expert; and wherein the processing device is further configured for:
determining a social connection between the candidate and an expert of the at least one expert based on the communicating; and
excluding the expert from the at least one expert based on determining the social connection.

20. The system of claim 12, wherein the storage device is further configured for:
recording the at least one evaluation session; and wherein the processing device is configured for:
analyzing the at least one evaluation session to determine at least one metric associated with the at least one evaluation session;
comparing the at least one metric with a plurality of metrics corresponding to a plurality of previous evaluation sessions corresponding to the at least one competence; and
determining a validity of the at least one evaluation session based on a result of the comparing, wherein the storing of the at least one proficiency rating is based on the validity.

21. The system of claim 12, wherein the processing device is further configured for:
analyzing the at least one evaluation session to determine at least one emotional state associated with the at least one expert; and
validating the at least one proficiency rating based on the at least one emotional state wherein the storing of the at least one proficiency rating is based on the validating.

22. The system of claim 12, wherein the communication device is further configured for:
receiving a job description from a database comprising job descriptions associated with a plurality of employers; and
transmitting a contract to a user device associated with at least one of the candidate and the employer based on identifying the candidate, wherein the processing device is further configured for:
analyzing the job description to determine at least one competency requirement; and
identifying the candidate based on the at least one competency requirement and the at least one proficiency rating.
